(19) United States
(12) Patent Application Publication
(10) Pub. No.: US 2025/0306390 A1
(43) Pub. Date: Oct. 2, 2025

(54) IMAGE STABILIZATION MECHANISM AND LENS BARREL EQUIPPED WITH SAME

(71) Applicant: Panasonic Intellectual Property Management Co., Ltd., Osaka (JP)

(72) Inventors: Kenichi MIYAMORI, Hyogo (JP); Makoto UMEDA, Osaka (JP); Yuichiro KIMOTO, Osaka (JP)

(73) Assignee: Panasonic Intellectual Property Management Co., Ltd., Osaka (JP)

(21) Appl. No.: 19/083,539

(22) Filed: Mar. 19, 2025

(30) Foreign Application Priority Data
Apr. 1, 2024 (JP) 2024-058950

(51) Int. Cl. G02B 27/64; G02B 7/02

(52) U.S. Cl. CPC G02B 27/646; G02B 7/021

(57) ABSTRACT

The image stabilization mechanism 20 includes a lens frame 21, a fixed frame 22, coils 23a and 23b, three balls 24, and a pressing mechanism 25. The coils 23a and 23b are provided to the lens frame 21, and the flow of current when the lens frame 21 is moved relative to the fixed frame 22generates a Lorentz force. The three balls 24 support the lens frame 21 in a rollable state between the fixed frame 22 and the lens frame 21. The pressing mechanism 25 applies a force to press the lens frame 21 against the fixed frame 22, and includes magnets 25a and 25b on the fixed frame 22 side, and magnetic bodies 25e and 25f disposed near the center of gravity G of the members on the movable side so as to be attracted by the magnets 25a and 25b and be opposite the magnets 25a and 25b in the lens frame 21.

### CROSS-REFERENCE TO RELATED APPLICATIONS

This application claims priority to Japanese Patent Application No. 2024-058950 filed on Apr. 1, 2024. The entire disclosure of Japanese Patent Application No. 2024-058950 is hereby incorporated herein by reference.

### BACKGROUND

### Technical Field

The present disclosure relates to an image stabilization mechanism that is mounted in a lens barrel, and a lens barrel that is equipped with this image stabilization mechanism.

### Description of the Related Art

Patent Document 1 discloses a lens barrel having a movable member that holds a lens group that moves parallel to an optical system consisting of a plurality of lens groups, some of which are for image stabilization, and which move parallel to a plane perpendicular to the optical axis, a fixed member that restricts the movable member in the optical axis direction, at least three balls that are sandwiched between the movable member and the fixed member and are able to move relative to each of the movable member and the fixed member within a limited range provided for the movable member or the fixed member, a biasing means for biasing the movable member toward the fixed member, two drive means for generating forces that move the movable member in two directions that are substantially perpendicular to each other, and two position sensing means that independently sense the position of the movable member in each of the two directions that are substantially perpendicular to each other.

### CITATION LIST

### patent literature

Patent Literature 1: JP-A 2001-290184

### SUMMARY

### Problem to be Solved by the Invention

However, the following problem is encountered with the above-mentioned conventional lens barrel.

That is, with the lens barrel disclosed in the above publication, a moment tends to be generated in the image stabilization mechanism, so the lens barrel cannot be said to be driven efficiently.

It is an object of the present disclosure to provide an image stabilization mechanism that can be driven efficiently by suppressing the generation of moment, and a lens barrel equipped with this image stabilization mechanism.

### Means for Solving Problem

The image stabilization mechanism according to the present disclosure includes a lens frame, a frame member, a coil, three or more spherical members, and a pressing mechanism. The lens frame holds an optical lens. The frame member is disposed adjacent in the optical axis direction of the lens frame. The coil is provided to the lens frame, and the flow of current when the lens frame is moved relative to the fixed frame generates a Lorentz force. The three or more spherical members are provided in a rollable state between the frame member and the lens frame and support the lens frame. The pressing mechanism applies a force to press the lens frame against the frame member, and has a magnet that is provided to the frame member, and a magnetic body that is attracted to the magnet and is disposed at a position opposite the magnet in the lens frame near the center of gravity of the members on the movable side including the lens frame.

### Effects

With the image stabilization mechanism according to the present disclosure, the generation of moment can be suppressed and efficient drive achieved.

### BRIEF DESCRIPTION OF THE DRAWINGS

FIG. 1 is an exploded oblique view of the configuration of a lens barrel including an image stabilization mechanism according to an embodiment of the present disclosure;

FIG. 2 is an oblique view of the configuration including the image stabilization mechanism included in the lens barrel of FIG. 1;

FIG. 3 is a cross-sectional view along the X-X line of the image stabilization mechanism in FIG. 2;

FIG. 4 is a plan view of the image stabilization mechanism in FIG. 2 as seen from the subject side;

FIG. 5 is a cross-sectional view along the A-B-C-D-E-F-G-H line of the image stabilization mechanism in FIG. 4;

FIG. 6 is a plan view of the layout of the main components of the image stabilization mechanism in FIG. 4;

FIG. 7 is a graph of the thrust distribution in the linear (yaw) direction of the image stabilization mechanism in FIG. 6;

FIG. 8 is a graph of the thrust distribution in the rotation (pitch) direction of the image stabilization mechanism in FIG. 6;

FIG. 9 is a plan view of a configuration in which the layout of a magnetic plate of the image stabilization mechanism in FIG. 6 is changed to a position offset from the center of gravity of the members on the movable side;

FIG. 10 is a cross-sectional view of the image stabilization mechanism shown in FIG. 9;

FIG. 11 is a plan view of the layout of the main components of the image stabilization mechanism according to another embodiment of the present disclosure;

FIG. 12 is a plan view of the layout of the main components of the image stabilization mechanism according to yet another embodiment of the present disclosure;

FIG. 13 is a plan view of the layout of the main components of the image stabilization mechanism according to yet another embodiment of the present disclosure;

FIG. 14 is a cross-sectional view of the image stabilization mechanism shown in FIG. 13;

FIG. 15 is a plan view of the layout of the main components of the image stabilization mechanism according to yet another embodiment of the present disclosure; and

FIG. 16 is a cross-sectional view of the image stabilization mechanism shown in FIG. 15.

### DETAILED DESCRIPTION OF THE EMBODIMENT

Embodiments pertaining to this disclosure will now be described through reference to the drawings. However, some unnecessarily detailed description may be omitted. For example, detailed description of already known facts or redundant description of components that are substantially the same may be omitted. This is to avoid unnecessary repetition in the following description, and facilitate an understanding on the part of a person skilled in the art.

The applicant has provided the appended drawings and the following description so that a person skilled in the art might fully understand this disclosure, but does not intend for these to limit what is discussed in the patent claims.

### Embodiment 1

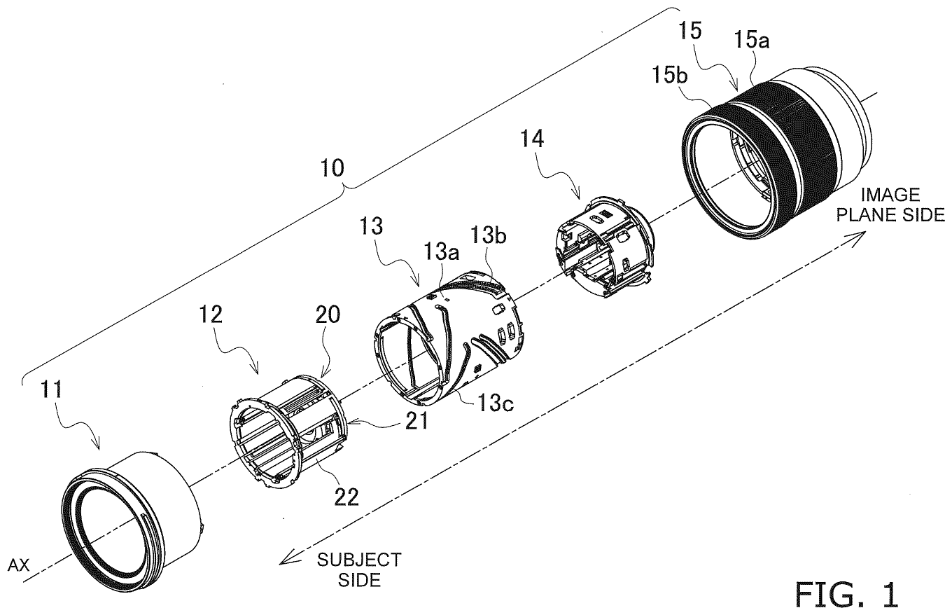

A lens barrel 10 equipped with an image stabilization mechanism 20 according to an embodiment of the present disclosure will now be described with reference to FIGS. 1 to 10.

### (1) Configuration of Lens Barrel 10

The lens barrel 10 according to this embodiment is removably attached to a camera body (not shown), and as shown in FIG. 1, includes a first lens group unit 11, an OIS (optical image stabilizer) unit 12, a cam frame 13, a focus unit 14, and an exterior unit 15.

As shown in FIG. 1, the first lens group unit 11 is a substantially cylindrical member that is disposed closest to the subject in the optical axis AX direction of all the components that constitute the lens barrel 10, and holds a first lens group on its inner peripheral surface.

The OIS (optical image stabilizer) unit 12 includes an image stabilization mechanism 20 (discussed below), and is equipped with a lens frame 21, a fixed frame 22, etc.

As shown in FIG. 1, the cam frame 13 is disposed on the outer peripheral surface side of the OIS unit 12, and has a substantially cylindrical main body portion 13a and a plurality of cam grooves 13b and 13c formed in the main body portion 13a. Cam pins (not shown) of the exterior unit 15 move in a state of being engaged with the cam grooves 13b and 13c.

As shown in FIG. 1, the focus unit 14 is disposed on the image plane side of the OIS unit 12 in the optical axis AX direction, and holds a focus lens on its inner peripheral surface side. The focus unit 14 has in its interior a focusing lens and a drive mechanism in the optical axis AX direction, and moves the focusing lens back and forth in the optical axis AX direction.

As shown in FIG. 1, the exterior unit 15 is a roughly cylindrical member that constitutes the exterior portion of the lens barrel 10, and has annular zoom ring 15a, focus ring 15b, etc., attached around its outer peripheral surface in a state of being rotatable in the peripheral direction.

### (2) Configuration of Image Stabilization Mechanism 20

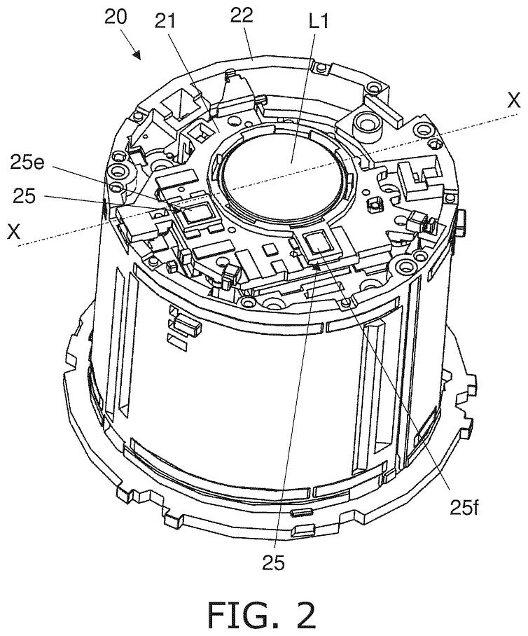

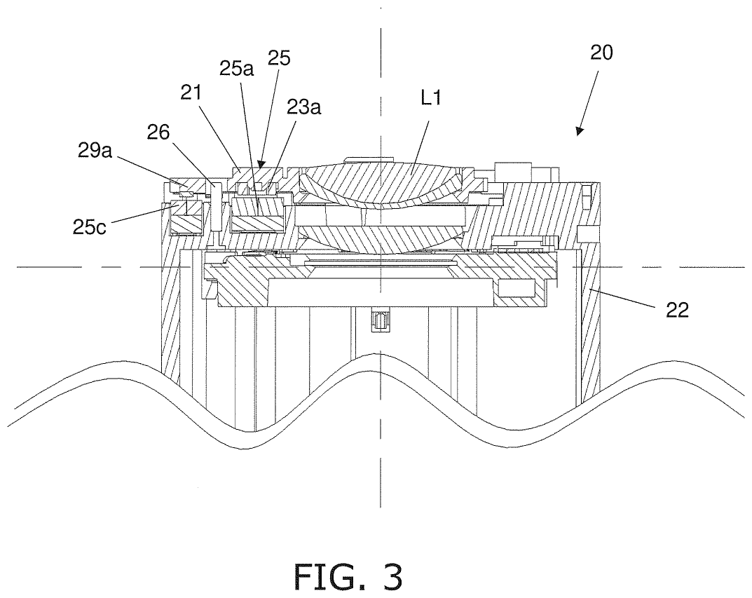

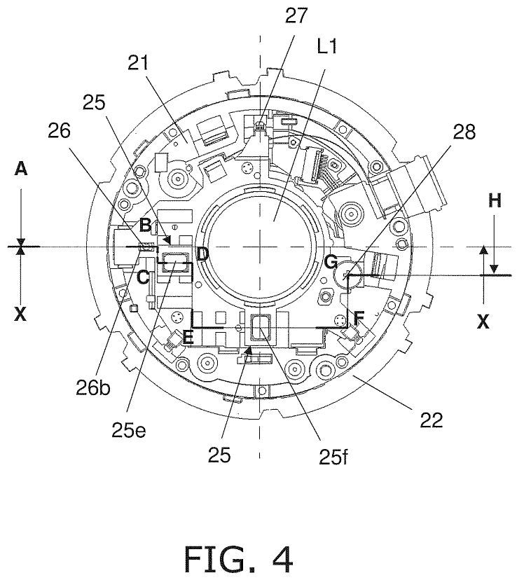

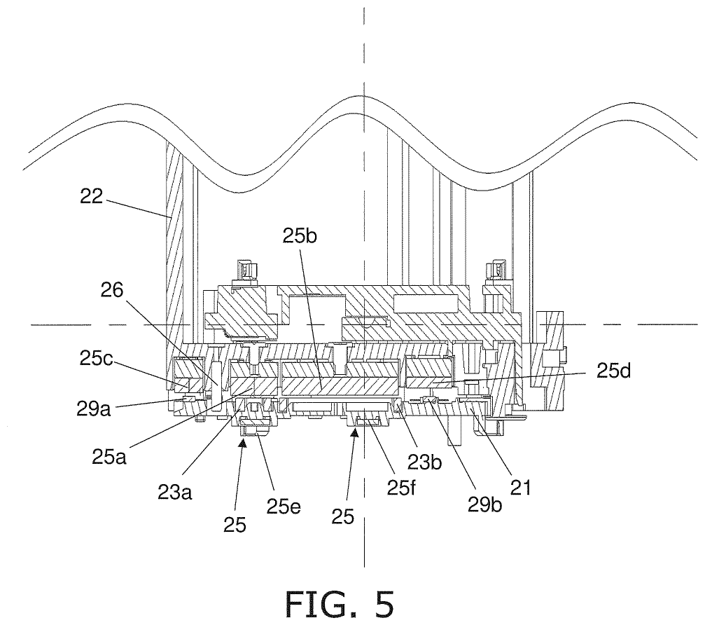

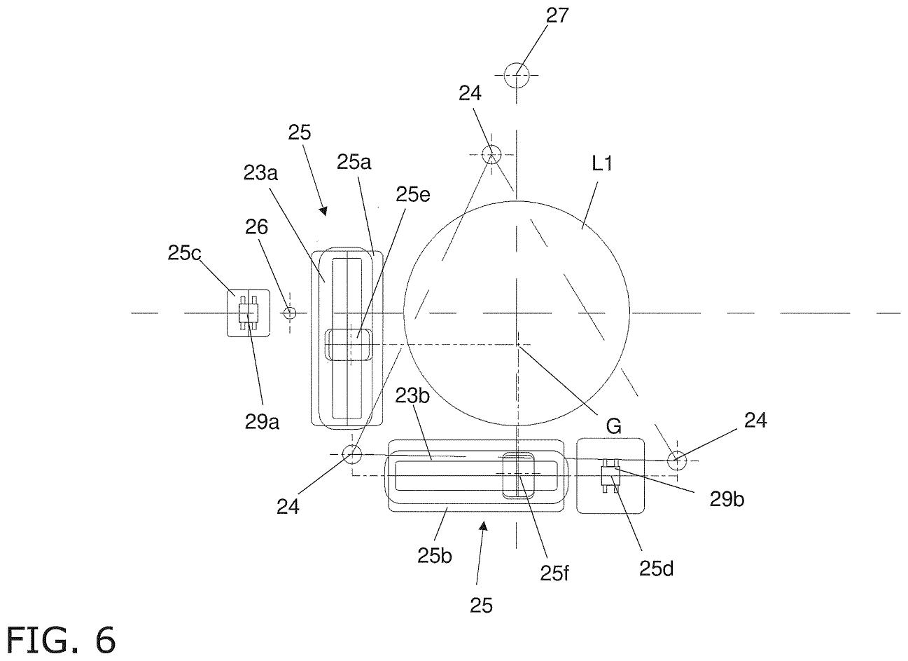

The image stabilization mechanism 20 according to this embodiment is a mechanism that makes use of what is called a moving coil system, and controls the lens frame 21 to move in the opposite direction from the direction of the detected camera shake. As shown in FIGS. 2 and 3, the image stabilization mechanism 20 includes the lens frame 21 that holds the optical lens L1, the fixed frame (frame member) 22, coils 23a and 23b (see FIG. 6), three balls (spherical members) 24 (see FIG. 6), a pressing mechanism 25, a rotation shaft 26, a thrust spring 27 (see FIG. 4), a retainer 28 (see FIG. 4), and position sensing elements 29a and 29b (see FIG. 5).

As shown in FIGS. 2 and 3, the lens frame 21 is a substantially flat member that holds the optical lens L1 in its center portion, and is attached in a state of being relatively movable with respect to the fixed frame 22. The lens frame 21 is supported at three points in the optical axis direction of the optical lens L1 by the three balls 24. The lens frame 21 is driven so as to move in the opposite direction from a direction of the detected camera shake by a gyro sensor (not shown) or the like when a current is passed through the coils 23a and 23b (discussed below).

As shown in FIGS. 4 and 5, the fixed frame (frame member) 22 is a substantially cylindrical member, and is disposed adjacent to the lens frame 21 in the optical axis direction. Magnets 25a, 25b, 25c, 25d, etc. (discussed below) are disposed on the fixed frame 22.

The coils 23a and 23b (see FIG. 6) are provided to the lens frame 21, and when current is passed through the coils to move the lens frame 21 relative to the fixed frame 22, the magnetic force of the adjacent magnets 25a and 25b generates a Lorentz force in the desired direction (the opposite direction from the direction of the camera shake).

As shown in FIG. 5, the coil 23a is provided to the lens frame 21, and is controlled so as to be energized and to move the lens frame 21 when camera shake is detected. When the lens frame 21 is driven toward the rectilinear motion side (yaw side), the coil 23a is energized to generate a Lorentz force by the magnetic force of the magnet 25a disposed opposite the fixed frame 22.

As shown in FIG. 5, the coil 23b is provided to the lens frame 21, and is controlled so as to be energized and to move the lens frame 21 when camera shake is detected. When the lens frame 21 is driven to the rotation side (pitch side), the coil 23b is energized to generate a Lorentz force by the magnetic force of the magnet 25b disposed opposite the fixed frame 22.

The three balls (spherical members) 24 (see FIG. 6) are provided in a rollable state between the fixed frame 22 and the lens frame 21, and support the lens frame 21 relative to the fixed frame 22.

The pressing mechanism 25 applies a force to press the lens frame 21 against the fixed frame 22, and has magnets 25a and 25b that are provided to the fixed frame 22, and magnetic plates 25e and 25f that are attracted to the magnets 25a and 25b and are positioned opposite the magnets 25a and 25b on the lens frame 21, near the center of gravity G of the members on the movable side, including the lens frame 21.

Here, “members on the movable side” refers to components including the optical lens L1, the lens frame 21, and the coils 23a and 23b, which are supported by the fixed frame 22 via the balls 24 and are driven by passing current through the coils 23a and 23b.

The detailed configuration of the pressing mechanism 25 will be described below.

As shown in FIGS. 4 and 5, the rotation shaft 26 is a rod-shaped member disposed along the optical axis direction, the first end of which is fixed to the fixed frame 22 side, and the second end on the lens frame 21 side is fitted into a slot 26b so as to be rotatable and linearly movable. The rotation shaft 26 serves as the center of rotation when the lens frame 21 is controlled to rotate in the pitch direction relative to the fixed frame 22. The side surfaces on the long sides of the slot 26b serve as sliding surfaces when the lens frame 21 is controlled to move linearly in the yaw direction.

As shown in FIG. 4, the thrust spring 27 is provided at the end of the lens frame 21 on the side where the pressing mechanism 25 is not provided. The thrust spring 27 applies a force that pulls the lens frame 21 toward the fixed frame 22 in the optical axis direction to prevent the end of the lens frame 21 from floating up and causing continuous large vibrations in the event of improper handling such as being dropped or subjected to an impact.

As shown in FIG. 4, the retainer 28 is provided on the upper surface of the lens frame 21 and passes through the lens frame 21 to be fixed to the fixed frame 22. The retainer 28 is attached so that the lens frame 21 will not move more than a specific distance away from the fixed frame 22 in the optical axis direction.

As shown in FIG. 5, the position sensing elements 29a and 29b are disposed on the lens frame 21 in order to sense the relative position of the lens frame 21 with respect to the fixed frame 22 when the lens frame 21 is driven by the image stabilization mechanism 20.

As shown in FIG. 5, the position sensing element 29a is disposed in a position opposite the magnet 25c used for position sensing on the rectilinear motion side (yaw side), and senses the relative position of the lens frame 21 with respect to the fixed frame 22 on the rectilinear motion side (yaw side).

As shown in FIG. 5, the position sensing element 29b is disposed in a position opposite the position sensing magnet 25d on the rotation side (pitch side), and senses the relative position of the lens frame 21 with respect to the fixed frame 22 on the rotation side (pitch side).

### (3) Configuration of Pressing Mechanism 25

As discussed above, the pressing mechanism 25 provided to the image stabilization mechanism 20 of this embodiment applies a force to press the lens frame 21 in the optical axis direction against the fixed frame 22. As shown in FIG. 6, the image stabilization mechanism 20 is provided with a total of two pairs: one pair of the magnet 25a and the magnetic plate 25e, and another pair of the magnet 25b and the magnetic plate 25f.

That is, the pressing mechanism 25 can press the lens frame 21 against the fixed frame 22 in the optical axis direction by using a first attractive force produced between the magnet 25a and the magnetic plate 25e, and a second attractive force produced between the magnet 25b and the magnetic plate 25f.

The magnet 25a is provided at a position opposite the coil 23a on the lens frame 21 side of the fixed frame 22 in order to drive the lens frame 21 on the rectilinear motion side (yaw side). The magnet 25a also generates an attractive force between itself and the magnetic plate 25e, thereby applying a force that presses the lens frame 21 against the fixed frame 22.

The magnetic plate 25e is disposed at a position opposite the magnet 25a on the rectilinear motion side (yaw side) in the optical axis direction, and is subjected to an attractive force with which it is attracted by the magnet 25a. The magnetic plate 25e is disposed at a position where the center of gravity G of the lens frame 21 (the members on the movable side) is projected onto the drive axes of the lens frame 21, as shown in FIG. 6.

That is, as shown in FIG. 6, the magnetic plate 25e is disposed at a position on the magnet 25a that is the shortest distance from the center of gravity G of the members on the movable side, including the lens frame 21, in plan view.

The magnet 25b is provided at a position opposite the coil 23b on the lens frame 21 side of the fixed frame 22 in order to rotate the lens frame 21 around the rotation shaft 26. The magnet 25b also applies a force to press the lens frame 21 against the fixed frame 22 by producing an attractive force between the magnet 25b and the magnetic plate 25f.

The magnetic plate 25f is disposed at a position opposite the magnet 25b on the rotation side (pitch side) in the optical axis direction, and is subjected to an attractive force with which it is attracted by the magnet 25b. The magnetic plate 25f, like the magnetic plate 25e, is disposed at a position where the center of gravity G of the lens frame 21 (the members on the movable side) is projected onto the drive axes of the lens frame 21, as shown in FIG. 6.

That is, as shown in FIG. 6, the magnetic plate 25f is disposed at a position on the magnet 25b that is the shortest distance from the center of gravity G of the members on the movable side, including the lens frame 21, in plan view.

Consequently, in the moving coil type of image stabilization mechanism 20 in which the coils 23a and 23b are attached to the movable side (lens frame 21), magnetic plates 25e and 25f are disposed at positions spaced a specific distance away from the magnets 25a and 25b fixed to the fixed side (fixed frame 22), and the magnetic attraction force generated between the magnetic plates 25e and 25f and the magnets 25a and 25b allows for biasing in the thrust direction (optical axis direction).

Therefore, since there is no need to disposed a conventional biasing-use tension coil spring around the outer peripheral part of the image stabilization mechanism 20, the lens barrel 10 can have a smaller diameter than in the past. Also, there will be no variance in the thrust force attributable to component variance, assembly variance of the tension coil spring, etc.

Furthermore, since the magnetic plates 25e and 25f are disposed at positions opposite the drive coils 23a and 23b sides with respect to the magnets 25a and 25b for driving the lens frame 21, the thrust can be increased.

Also, compared to a moving magnet system in which a magnet is disposed on the movable side, the movable side (lens frame 21, etc.) is lighter, so the actuator (anti-G) performance can be improved.

Furthermore, with the image stabilization mechanism 20 of this embodiment, the magnetic plates 25e and 25f are disposed at positions opposite each other in the optical axis direction on the existing drive magnets 25a and 25b used for moving the lens frame 21 relative to the fixed frame 22.

Consequently, there is no need to provide a separate magnet to press the lens frame 21 against the fixed frame 22 in the optical axis direction, so this avoids an increase in the number of parts and an increase in weight.

Also, since the magnetic plates 25e and 25f are disposed at positions opposite the drive magnets 25a and 25b in the rectilinear (yaw) direction and the rotational (pitch) direction, respectively, the magnetic flux density interlinked with the drive coils 23a and 23b is increased, which in turn increases thrust.

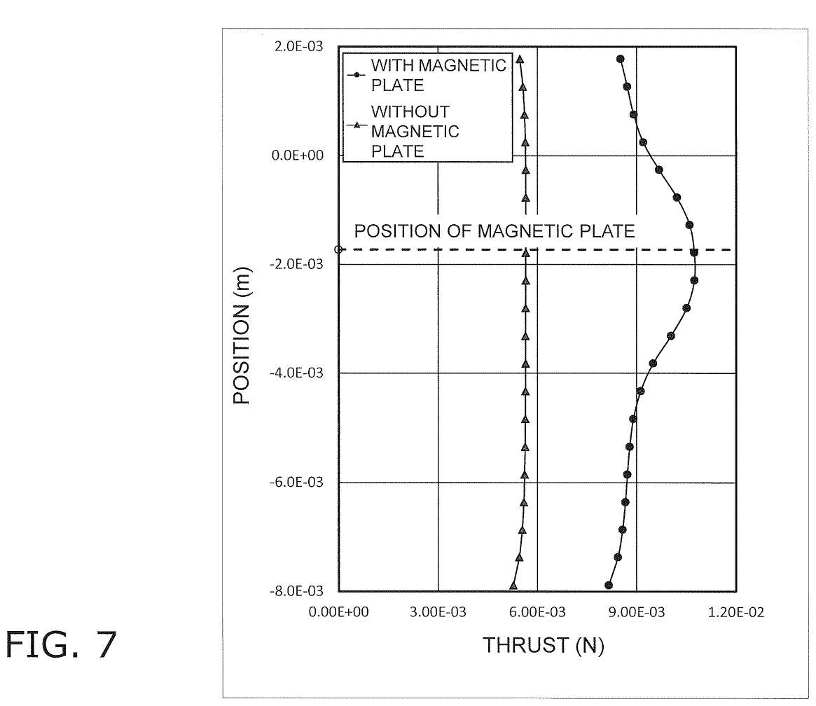

More specifically, as shown in FIG. 7, the thrust distribution in the rectilinear (yaw) direction is such that in a configuration in which the magnetic plates 25e and 25f are not disposed, a thrust of approximately 5.00×10⁻³ (N) is generated, whereas in a configuration in which the magnetic plate 25e is disposed, a thrust of approximately 8.00 to 11.00×10⁻³ (N) is generated. In particular, the maximum thrust is obtained at the position where the magnetic plate 25e is disposed, as shown by the dashed line in FIG. 7.

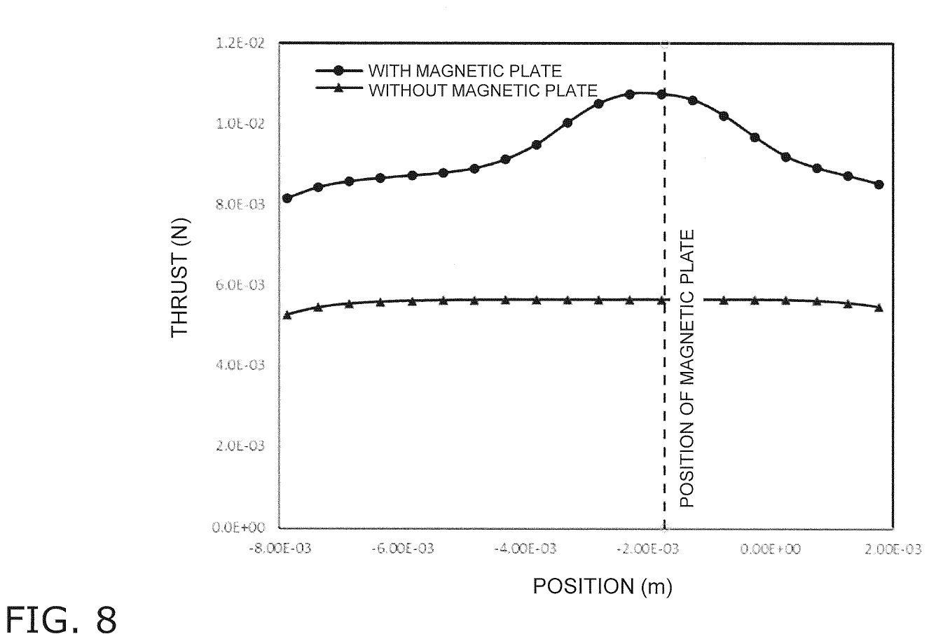

Similarly, as shown in FIG. 8, the thrust distribution in the rotation (pitch) direction is such that a thrust of approximately 5.00×10⁻³ (N) was generated, whereas in a configuration in which the magnetic plate 25f is disposed, a thrust of approximately 8.50 to 11.00×10⁻³ (N) was generated. In particular, the maximum thrust was obtained at the position where the magnetic plate 25f was disposed, as shown by the dashed line in FIG. 8.

Consequently, in an actuator in which the magnets 25a and 25b and the coils 23a and 23b are disposed a specific distance apart and current is passed through the coils 23a and 23b to drive the lens frame 21, the thrust near the positions where magnetic plates 25e and 25f are disposed is higher when the magnetic plates 25e and 25f for biasing the lens frame 21 in the optical axis (thrust) direction are disposed near the magnets 25a and 25b. Accordingly, the portion of the center of gravity G of the members on the movable side can be driven by disposing the magnetic plates 25e and 25f of the actuators at the center of gravity G of the lens frame 21, etc., on the movable side, which allows for efficient drive without generating any moment.

With the image stabilization mechanism 20 of this embodiment, in particular, the magnetic plates 25e and 25f are disposed at positions where the center of gravity G of the members on the movable side, including the lens frame 21, is projected in the rectilinear (yaw) direction and the rotational (pitch) direction.

This suppresses the generation of moment and affords more efficient drive. Major Features

As shown in FIG. 6, the image stabilization mechanism 20 of this embodiment includes the lens frame 21, the fixed frame 22, the coils 23a and 23b, the three balls 24, and the pressing mechanism 25. The lens frame 21 holds the optical lens L1. The fixed frame 22 is disposed adjacent to the lens frame 21 in the optical axis direction. The coils 23a and 23b are provided to the lens frame 21, and when the lens frame 21 is moved relative to the fixed frame 22, current flows through the coils 23a and 23b to generate a Lorentz force. The three balls 24 are provided in a rollable state between the fixed frame 22 and the lens frame 21, and support the lens frame 21. The pressing mechanism 25 applies a force to press the lens frame 21 against the fixed frame 22, and has the magnets 25a and 25b provided to the fixed frame 22, and the magnetic plates 25e and 25f that are attracted to the magnets 25a and 25b and are positioned opposite the magnets 25a and 25b on the lens frame 21, near the center of gravity G of the members on the movable side, including the lens frame 21.

Consequently, in a moving coil type of image stabilization mechanism 20 in which the coils 23a and 23b are attached to the lens frame 21, the magnetic plates 25e and 25f are disposed at positions opposite the magnets 25a and 25b fixed to the fixed frame 22, which allows biasing in the thrust direction (optical axis direction) by the magnetic attraction force generated between the magnetic plates 25e and 25f and the magnets 25a and 25b.

Also, since the magnetic plates 25e and 25f are disposed at positions opposite the magnets 25a and 25b and near the center of gravity G of the members on the movable side, including the lens frame 21, a force can be applied near the center of gravity of the members on the movable side, including the lens frame 21.

As a result, in the image stabilization mechanism 20 that employs a so-called moving coil system, the generation of moment can be suppressed and the mechanism can be driven more efficiently.

### Other Embodiments

An embodiment of the present disclosure was described above, but the present disclosure is not limited to or by the above embodiment, and various modifications are possible without departing from the gist of the disclosure.

### (A)

In the above embodiment, an example was given in which the magnetic plates 25e and 25f of the pressing mechanism 25 included in the image stabilization mechanism 20 of the present disclosure were disposed at positions projected onto the drive axes from the center of gravity G of the members on the movable side (the positions at the shortest distance on the magnets 25a and 25b). However, the present disclosure is not limited to this.

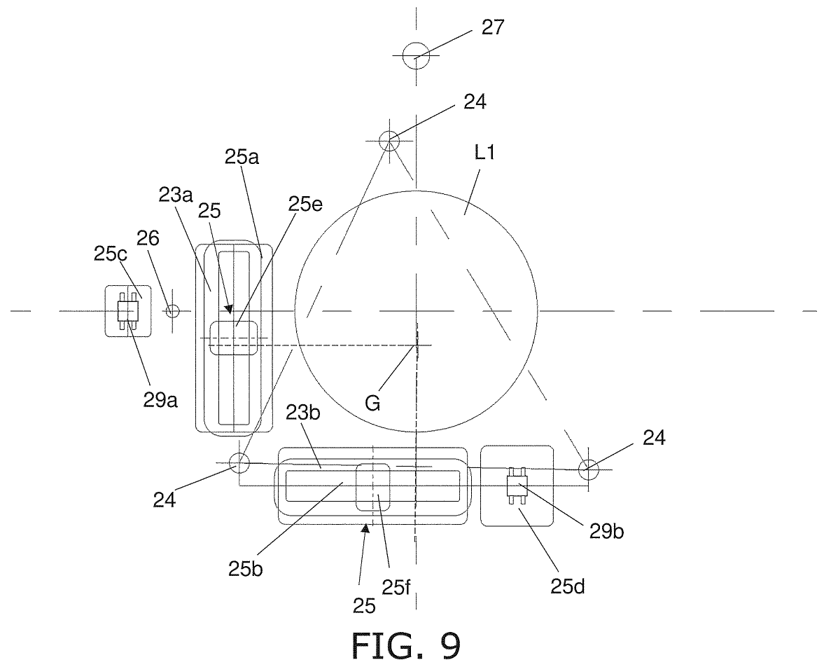

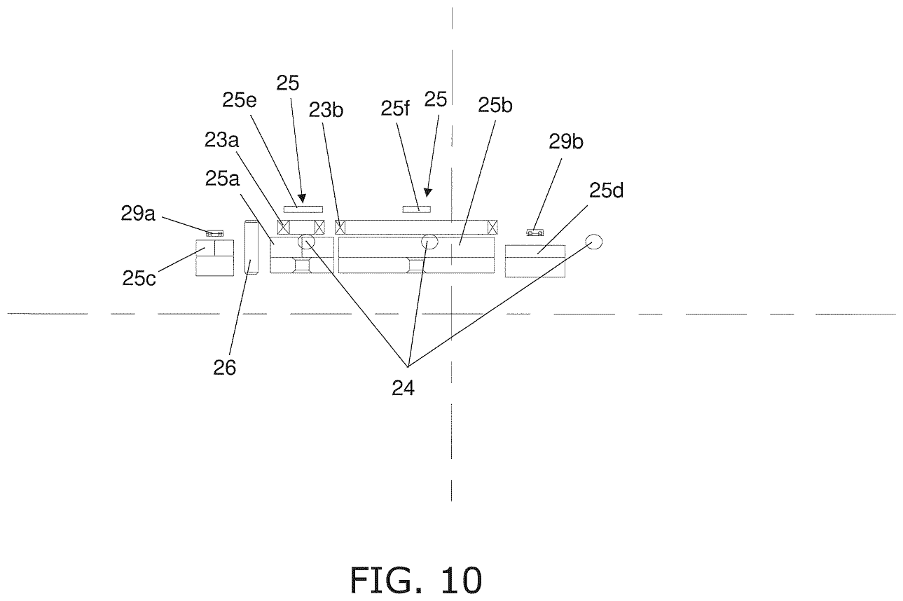

For example, as shown in FIGS. 9 and 10, only the one magnetic plate 25e may be disposed at a position projected from the center of gravity G of the members on the movable side onto the drive axes (the position at the shortest distance on the magnet 25a), and the other magnetic plate 25f may be positioned at a position offset from the position projected from the center of gravity G of the members on the movable side onto the drive axes (the position at the shortest distance on the magnet 25b).

### (B)

In the above embodiment, an example was given in which the center of gravity G of the members on the movable side, including the lens frame 21, was disposed at a position shifted downward in the drawings from the position of the optical axis center of the optical lens L1, and the magnetic plates 25e and 25f were disposed at positions where this center of gravity G was projected onto the drive axes of the rectilinear motion side and the rotation side. However, the present disclosure is not limited to this.

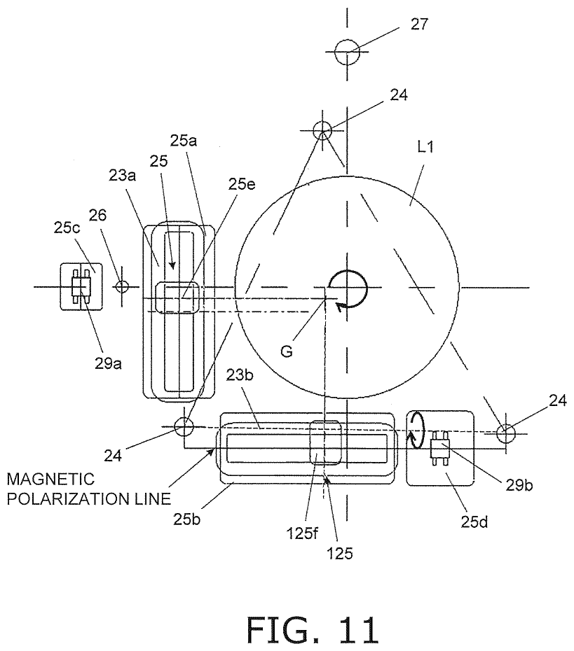

For example, as shown in FIG. 11, the center of gravity G of the members on the movable side including the lens frame 21 may be located at a position shifted to the left and down in the drawing from the position of the optical axis center of the optical lens L1, and the pressing mechanism 125 may have magnetic plates 25e and 125f disposed at positions where this center of gravity G is projected onto the drive axes of the rectilinear motion side and rotational side.

In this case, in order to suppress disturbance around the optical axis, the position where maximum thrust is generated is aligned with the position of the center of gravity G of the magnetic plates 25e and 25f, which effectively suppresses the generation of moment force around the optical axis of the lens frame 21.

Also, as shown in FIG. 11, a force that biases the lens frame 21 toward the center of gravity G can be generated by disposing the magnetic plate 25f to be offset toward the center of gravity G from the magnetic polarization lines.

Furthermore, in this embodiment, the position of the magnetic plate 125f is shifted toward the center of gravity to the point on a straight line connecting two of the three balls 24 that surround the two sides of the magnetic plate 125f. Therefore, the moment around the axis connecting the two balls that surround the two sides of the magnetic plate 125f, which is generated by the attractive force (pressing force) in the optical axis direction, becomes very small, and one mode of chattering vibration in the optical axis direction can be suppressed.

### (C)

In the above embodiment, an example was given in which the three balls 24 were disposed to form a substantially equilateral triangle in plan view, and the magnetic plates 25f was disposed only on the base side of the triangle in the drawing, as shown in FIG. 6, etc. However, the present disclosure is not limited to this.

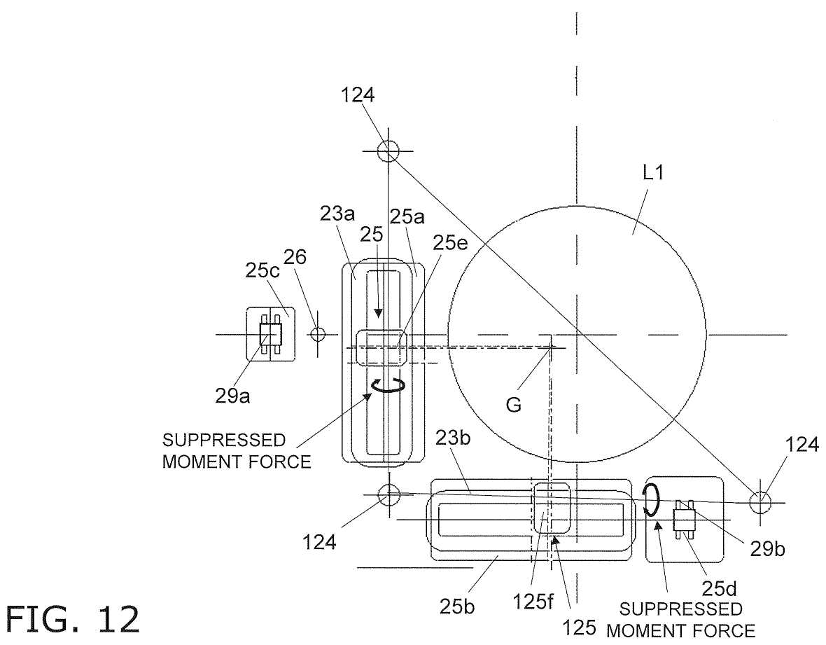

For example, as shown in FIG. 12, three balls (spherical members) 124 may be disposed so as to surround the center of gravity G of the members on the movable side including the lens frame 21, and two magnetic plates 25e and 125f may be both disposed on the sides of a triangle (polygon) connecting the three balls 124.

In this case, as shown in FIG. 12, there is less generation of moment forces around the two axes connecting two of the three balls 124 located on the two sides of the magnetic plates 25e and 25f by the magnetic force (pressing force), and this suppresses chattering vibration in the optical axis direction.

### (D)

As shown in FIGS. 5 and 6, in the above embodiment, an example was given in which the magnetic plates 25e and 25f constituting the pressing mechanism 25 were disposed at positions on the lens frame 21 side opposite the magnets 25a and 25b disposed on the fixed frame 22 side in order to drive the lens frame 21. However, the present disclosure is not limited to this.

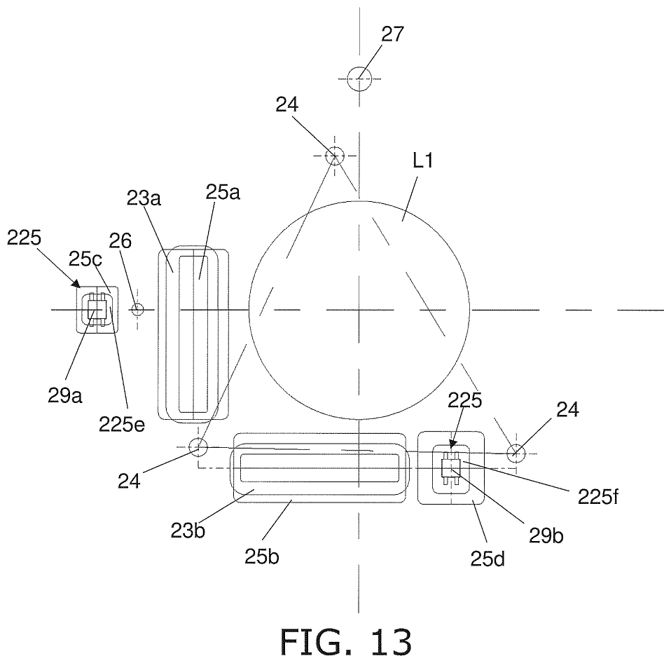

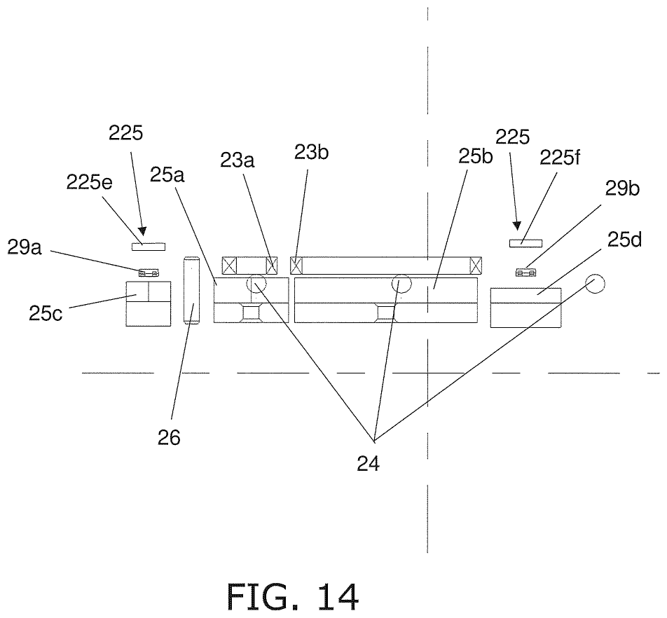

For example, as shown in FIGS. 13 and 14, the pressing mechanism 225 may be configured such that magnetic plates 225e and 225f are disposed at positions on the lens frame 21 side opposite the magnets 25c and 25d disposed on the fixed frame 22 side in order to sense the position of the lens frame 21.

Here again, just as with the drive magnets 25a and 25b and the magnetic plates 25e and 25f disposed opposite these, a force can be applied between the position detection magnets 25c and 25d and the magnetic plates 225e and 225f disposed opposite these to press the lens frame 21 toward the fixed frame 22 in the optical axis direction.

### (E)

As shown in FIGS. 5 and 6, in the above embodiment, an example was given in which the magnetic plates 25e and 25f constituting the pressing mechanism 25 were disposed only on the lens frame 21 side opposite the magnets 25a and 25b disposed on the fixed frame 22 side in order to drive the lens frame 21. However, the present disclosure is not limited to this.

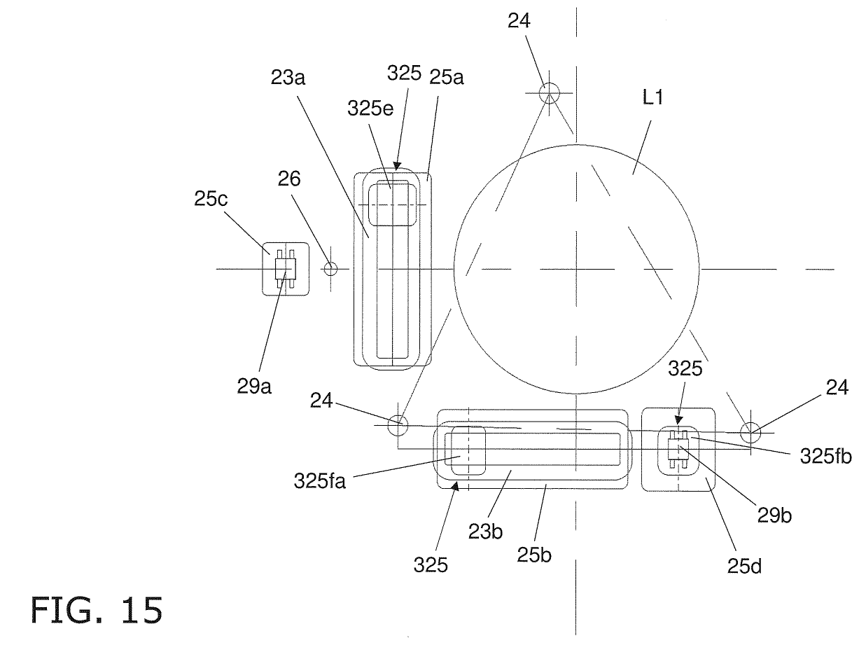

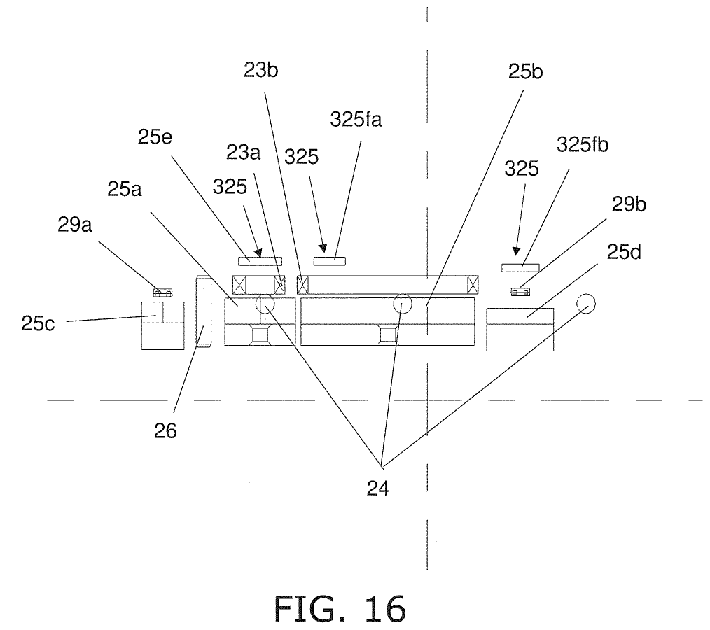

For example, as shown in FIGS. 15 and 16, a pressing mechanism 325 may be provided in which magnetic plates 325e, 325fa, and 325fb are disposed at positions opposite the magnets 25a and 25b on the drive side, as well as at a position opposite the magnet 25d used for position sensing on the rotation side.

Instead of or in addition to the magnet 25d for sensing the position of the rotation side, a pressing mechanism may be configured by disposing a magnetic plate at a position opposite the magnet 25c for sensing the position of the rectilinear motion side.

### (F)

In the above embodiment, an example was given in which the three balls 24 were used as spherical members that supported the lens frame 21 relative to the fixed frame 22. However, the present invention is not limited to this.

For example, the number of spherical members is not limited to three, and may instead be four or more.

### (G)

In the above embodiment, an example was given in which the flat magnetic plates 25e and 25f were used as the magnetic bodies that constituted the pressing mechanism 25. However, the present invention is not limited to this.

For example, the magnetic body does not have to be in a flat shape, and may have some other shape.

### (H)

In the above embodiment, an example was given in which the configuration of the present disclosure was applied to the lens barrel 10 that was removably attached to the camera body, but the present invention is not limited to this.

For example, the configuration of the present disclosure may be applied to a lens barrel that is fixed in a non-removable manner to a camera body.

### Additions

The above description of the embodiments discloses the following techniques.

### Technique 1

The image stabilization mechanism according to Technique 1 includes:
a lens frame that holds an optical lens;
a frame member that is disposed adjacent to the lens frame in the optical axis direction;
a coil that is provided to the lens frame, and which generates a Lorentz force upon the flow of current when the lens frame is moved relative to the frame member;
three or more spherical members that are provided between the frame member and the lens frame in a rollable state and support the lens frame; and a pressing mechanism that applies a force to press the lens frame against the frame member, the pressing mechanism having a magnet provided to the frame member, and a magnetic body that is attracted to the magnet and is disposed in a position opposite the magnet on the lens frame and near the center of gravity of the members on the movable side including the lens frame.

### Technique 2

The image stabilization mechanism according to Technique 2 is the image stabilization mechanism according to Technique 1,
wherein the magnetic bodies are disposed at positions obtained by projecting the center of gravity of the lens frame onto the drive axes of the lens frame.

### Technique 3

The image stabilization mechanism according to Technique 3 is the image stabilization mechanism according to Technique 1 or 2,
wherein the magnetic body is disposed such that the center of gravity is closer to the center of gravity on a side of the movable members than a polarization line of the magnet.

### Technique 4

The image stabilization mechanism according to Technique 4 is the image stabilization mechanism according to any of Technique 1 to 3,
wherein the three or more spherical members are disposed to surround the center of gravity of the lens frame, and at least one of the magnetic bodies is disposed on a side of a polygon connecting the three or more spherical members, or inside the polygon.

### Technique 5

The image stabilization mechanism according to Technique 5 is the image stabilization mechanism according to any of Techniques 1 to 4,
wherein the magnet is provided near the coil in order to drive the lens frame.

### Technique 6

The image stabilization mechanism according to Technique 6 is the image stabilization mechanism according to Technique 5,
wherein the magnetic bodies are disposed at positions opposite the magnets provided for driving the lens frame in the yaw direction and the pitch direction, respectively.

### Technique 7

The image stabilization mechanism according to Technique 7 is the image stabilization mechanism according to any of Techniques 1 to 6,
wherein the magnet is provided to sense the position of the lens frame relative to the frame member.

### Technique 8

The lens barrel according to Technique 8 includes:
the image stabilization mechanism according to any of Techniques 1 to 7; and
an optical system including a plurality of optical lenses.

### INDUSTRIAL APPLICABILITY

The image stabilization mechanism of the present disclosure exhibits the effect of suppressing the generation of moment, which affords more efficient drive, and as such is widely applicable to various kinds of lens barrel equipped with an image stabilization mechanism.

### REFERENCE SIGNS LIST

10 lens barrel
11 first lens group unit
12 OIS unit
13 cam frame
13a main body portion
13b, 13c cam groove
14 focus unit
15 exterior unit
15a zoom ring
15b focus ring
20 image stabilization mechanism
21 lens frame
22 fixed frame (frame member)
23a coil
23b coil
24 ball (spherical member)
25 pressing mechanism
25a magnet
25b magnet
25c magnet
25d magnet
25e magnetic plate (magnetic body)
25f magnetic plate (magnetic body)
26 rotation shaft
27 thrust spring
28 retainer
29a, 29b position sensing element
124 ball (spherical member)
125 pressing mechanism
125f magnetic plate (magnetic body)
225 pressing mechanism
225e magnetic plate (magnetic body)
225f magnetic plate (magnetic body)
325 pressing mechanism
325e magnetic plate (magnetic body)
325fa magnetic plate (magnetic body)
325fb magnetic plate (magnetic body)
L1 optical Lens

What is claimed is:

1. An image stabilization mechanism, comprising:
a lens frame that holds an optical lens;
a frame member that is disposed adjacent to the lens frame in an optical axis direction;
a coil that is provided to the lens frame, through which a current flows and is configured to generate a Lorentz force when the lens frame is moved relative to the frame member;
three or more spherical members that are provided in a rollable state between the frame member and the lens frame, and that support the lens frame; and
a pressing mechanism configured to apply a force to press the lens frame against the frame member, the pressing mechanism having a magnet provided to the frame member, and a magnetic body that is attracted to the magnet and is disposed at a position opposite the magnet on the lens frame and near a center of gravity of movable members including the lens frame.

2. The image stabilization mechanism according to claim 1,
wherein the magnetic body is disposed at the positions where the center of gravity of the lens frame is projected onto each drive shaft of the lens frame.

3. The image stabilization mechanism according to claim 1,
wherein the magnetic body is disposed such that the center of gravity is closer to the center of gravity on a side of the movable members than a polarization line of the magnet.

4. The image stabilization mechanism according to claim 1,
wherein the three or more spherical members are disposed so as to surround the center of gravity of the lens frame, and
at least one of the plurality of magnetic bodies is disposed on a side of a polygon connecting the three or more spherical members, or inside the polygon.

5. The image stabilization mechanism according to claim 1,
wherein the magnet is provided near the coil in order to drive the lens frame.

6. The image stabilization mechanism according to claim 5,
wherein the magnetic bodies are disposed at positions opposite the magnets provided for driving the lens frame in a yaw direction and a pitch direction, respectively.

7. The image stabilization mechanism according to claim 1,
wherein the magnet is provided in order to sense a position of the lens frame relative to the frame member.

8. A lens barrel, comprising:
the image stabilization mechanism according to claim 1; and
an optical system including a plurality of optical lenses.
